(19) United States
(12) Patent Application Publication
(10) Pub. No.: US 2005/0078551 A1
(43) Pub. Date: Apr. 14, 2005

(54) Granulating mixers

(76) Inventors: Pierre Descamps, Rixensart (BE); Bertrand Michel, Heswall (GB); Marc Thibaut, Godarville (BE)

Correspondence Address: MCKELLAR IP LAW, PLLC, 784 SOUTH POSEYVILLE ROAD, MIDLAND, MI, 48640, US

(21) Appl. No.: 10/500,681

(22) PCT Filed: Jan. 9, 2003
(86) PCT No.: PCT/EP03/00881

(30) Foreign Application Priority Data
Jan. 15, 2002 (GB) 0200765.6

(51) Int. Cl. B01F 7/20

(52) U.S. Cl. 366/168.1; 366/328.1

(57) ABSTRACT

A mixer blade which is adapted to be mounted on the shaft of a vertical continuous granulating mixer, characterised in that an inner portion of the leading edge of the blade is bevelled upwards and an outer portion of the leading edge of the blade is substantially vertical or is bevelled downwards. A vertical continuous granulating mixer which comprises a shaft fitted with blades rotating within a tubular housing and having an inlet for solid particles and a spray inlet for liquid to contact the solid particles above the blades, characterised in that an inner portion of at least one of the blades is angled forwards and upwards over at least part of its area so that particles hitting the angled portion of the blade acquire an upwards velocity component.

This invention relates to granulating mixers, that is mixers capable of forming granules by agglomeration of smaller particles, and to blades for use in such mixers.

The invention is particularly concerned with vertical continuous granulating mixers. Such mixers comprise a substantially vertical shaft fitted with blades rotating within a tubular housing. The shaft is aligned with the housing and the blades have a predetermined clearance from the inner wall of the housing. The mixer has an inlet for solid particles which are to be agglomerated in the mixer and a spray inlet for liquid to contact the carrier particles above the blades. Contact with the liquid agglomerates the particles into granules; the liquid acts as a binder by absorbing the kinetic energy of colliding particles. Examples of such vertical continuous granulating mixers are described in U.S. Pat. No. 4,767,217 and EP-A-744215. The granulated product is usually fed to a fluidised bed which cools and/or dries the granules and fluidises them for transport to a packing station.

One characteristic of vertical continuous granulating mixer technology is that the residence time in the mixing chamber is very short, for example about 1 second. This gives the important advantage of high throughput, but a consequence of this low residence time in the equipment is that the particle size distribution of granules at the outlet can be rather large, including fines and oversize material. Fines can be recovered in a filter coupled with the fluidized bed cooler and/or in a classification unit and recycled with fresh particles feeding the mixer, and oversize material can be collected, crushed down and mixed with the granulated product in a fluidized bed, but both fines and oversize material have an adverse impact on the productivity of the agglomeration and its stability. In addition, a wider particle size distribution of the final granules usually results in poorer flow properties that may affect the ease of dosing and mixing of the granules in powder or granule products.

A vertical continuous granulating mixer according to the invention comprises a shaft fitted with blades rotating within a tubular housing and having an inlet for solid particles and a spray inlet for liquid to contact the solid particles above the blades, and is characterised in that an inner portion of the blade is angled forwards and upwards over at least part of its area so that particles hitting the angled portion of the blade acquire an upwards velocity component at the centre of the mixer.

According to another aspect of the invention a mixer blade adapted to be mounted on the shaft of a vertical continuous granulating mixer is characterised in that an inner portion of the leading edge of the blade is bevelled upwards and an outer portion of the leading edge of the blade is substantially vertical or is bevelled downwards. The invention also includes a vertical continuous granulating mixer comprising a shaft fitted with blades rotating within a tubular housing in which at least one of the blades is such a mixer blade. Particles hitting the blade acquire an upwards velocity component at the centre of the mixer and a downwards velocity component for the particles located in the vicinity of the mixer wall.

The invention also includes a granulation process in which solid particles and a liquid having binding properties are fed to a mixer and are contacted in the mixer to form granules, characterised in that the mixer is a vertical continuous granulating mixer as defined above.

The granulation process can for example be used to prepare a liquid active material in granular form, for example for incorporation into a granular or powder composition. In this case the liquid fed to the mixer comprises the liquid active material, with an added binder material if necessary, and the particles fed to the mixer are carrier particles. Alternatively the granulation process can be used to agglomerate an active material in powder form into granules of larger particle size. In this case the particles fed to the mixer are the active powder material and the liquid is generally chosen for its binder properties.

We have found by mathematical modelling and by experimental observations using a light scattering technique that the vast majority of collisions of particles and agglomerations take place in a high particles density zone located around the outer region of the blades near the wall of the mixer. The movement towards the wall is driven by the centrifugal force. We have also found that if the dimension of the particles fed to the mixer is below a certain critical size (typically about 10 microns), the particles that initially fall in the middle of the mixer take a long time to reach the high particles density zone. These particles stay at the center and fall down between the mixer blades in the inner region near the shaft, and have a low probability of collision. They are thus collected as fine particles, forming an undesirably large fraction of the product. Particles above the critical size move readily to the high particle density zone and generally agglomerate to form granules of acceptably narrow particle size distribution.

In previously disclosed vertical continuous granulating mixers, the blades have their side face parallel to the axis of rotation of the mixer so the particles that hit the blades do not acquire any velocity component oriented in the direction of the mixer axis. In the mixer according to the invention, the new blade is angled with an inclination towards the top of the mixer, giving to the particle a velocity component towards the mixer inlet. By increasing the relative velocity between incoming particles that fall in the mixer by gravity and the particles which have hit the blades, the probability of agglomeration of these particles located near the mixer center is increased. In the outer region of the mixer close to the wall, particle density is higher. Preferably, an angle of opposite sign is beveled in the outer region of the blades, so that a velocity component is given downwards to decrease the residence time of particles located in this high density region and so prevent the formation of oversize particles.

The invention will now be described with reference to the accompanying drawings, of which:

FIG. 1 is a diagrammatic cross-section of a vertical continuous high shear granulating mixer;

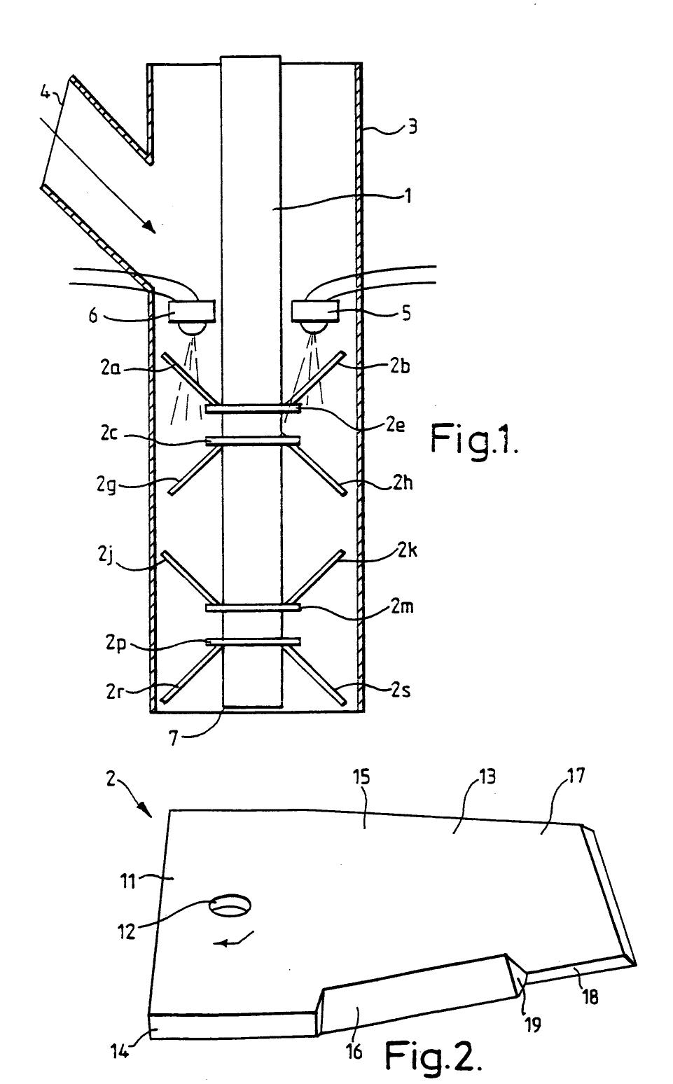

FIG. 2 is a diagrammatic perspective view of a mixer blade according to the invention for use in a mixer of the type shown in FIG. 1;

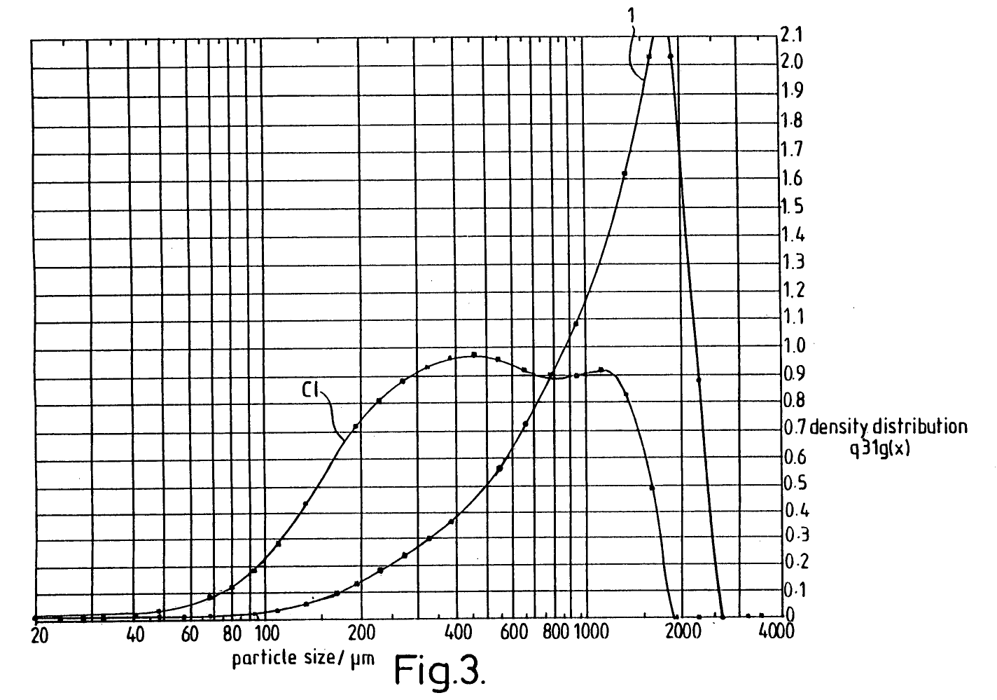

FIG. 3 is a graph showing the particle size distribution of the product of Example 1.

The mixer of FIG. 1 comprises a vertical shaft (1) fitted with blades (2) rotating within a tubular housing (3). Particles are fed to the mixer through powder inlet (4). Below the powder inlet (4) but above the blades (2), the shaft (1) is surrounded by spraying nozzles (5) through which liquid is fed. The wall (6) of the housing may be a deformable wall extended under pressure as described in EP-A-744215. The agglomerated granular product leaves the mixer through outlet (7). One example of such a mixer is a Flexomix mixer supplied by Hosokawa Schugi.

The blades (2) of the mixer of FIG. 1 are arranged in opposed pairs. Upper blades (2a and 2b) are mounted so that they extend upwards towards the wall (6). A pair of blades (2c and 2d not visible) are mounted at the same point along the shaft (1) as blades (2a, 2b) but extending horizontally. Another pair of horizontal blades (2e and 2f not visible) are mounted lower on shaft (1) and at the same point a pair of blades (2g and 2h) are mounted so that they extend downwards towards the wall (6). The blades (2a to 2h) form an upper set of blades. As shown in FIG. 1, the horizontal blades (2c, 2d, 2e, 2f) are circumferentially offset to the angled blades (2a, 2b, 2g, 2h); it may be preferred that the downwardly extending blades (2g, 2h) are circumferentially offset to the upwardly extending blades (2a, 2b) and that the blades (2e, 2f) are circumferentially offset to the blades (2c, 2d). A lower set of blades (2j to 2s) is mounted further down the shaft, consisting of blades (2j and 2k) extending upwards towards the wall (6) and a pair of horizontal blades (2m and 2n not visible) mounted at the same point along shaft (1), and a further pair of horizontal blades (2p and 2q not visible) mounted at the same point as blades (2r and 2s) extending downwards towards wall (6). In known mixers, all these blades (2) have their side face parallel to the axis of rotation of the mixer, that is parallel to shaft (1) and wall (6). The blades (2) may be in sets of six blades instead of eight, with only one pair of horizontal blades between the angled blades (2j and 2k) and (2r and 2s). The mixer can have three sets of blades.

Referring to FIG. 2, the blade (2) has a central portion (11), including hole (12) whereby blade (2) is attached to shaft (1) so as to rotate in the direction shown by the arrow, and a main portion (13) which tapers slightly in cross-section. The leading edge (14) of central portion (11) is perpendicular to the face of the blade and when mounted will be parallel to shaft (1) and enclosed in a blade holder surrounding the shaft. Over the main part (13) of the blade (2), in an inner portion (15) the leading edge (16) is bevelled upwards so that when it strikes a particle falling down the mixer, it imparts to the particle a velocity component towards the mixer inlets (4,5). The leading edge (16) of the inner portion (15) of the blade (2) is bevelled upwards at an angle of 30 to 75 degrees to its direction of travel. In an outer portion (17), the leading edge (18) is bevelled downwards so that when it strikes a particle it imparts a velocity component towards the outlet (7) of the mixer. This accelerates particles located in the high particle density zone close to the wall (6) towards the mixer outlet (7), to decrease their residence time in the high particle density zone and thus prevent the creation of very large, oversized agglomerates. The leading edge (18) of the outer portion (17) of the blade (2) is bevelled downwards at an angle of 45 to 80 or 85 degrees to its direction of travel. The inner portion (15) of the blade whose leading edge (16) is bevelled upwards is immediately adjacent to the outer portion (17) of the blade whose leading edge (18) is bevelled downwards, with an abrupt change in the angle of the leading edge (at 19). This transition point (19) is preferably positioned at 50 to 80% of the distance between central portion (11) and the tip (20) of the blade (2). The location of the transition point (19) is preferably arranged to correspond to the border of the high particle density outer region. The thickness of this region depends on mixer size and also on the velocity of rotation of the blades. The transition point (19) can be determined experimentally or via mathematical modelling. The optimum value of the upwards angle of the inner portion (15) and the downwards angle of the outer portion (17) of blade (2) also depend on the radius of the mixer and on the rotation speed of the blades.

According to the invention, at least one of the blades (2) in the mixer of FIG. 1 has the form shown in FIG. 2. Since the blades (2) are arranged in pairs, it is generally preferred that both blades of a pair have the same design. All the blades (2a to 2s) may be of this form, but we have found that the blades of FIG. 2 are particularly effective when used in the upper set of blades (2a to 2h). For example all the blades (2a to 2h), or all the angled blades (2a, 2b, 2g, 2h), or just the lower angled blades (2g, 2h), or the uppermost four blades (2a to 2d) may be of the form shown in FIG. 2, with the remaining blades, if any, in the upper set and all the blades (2j to 2s) in the lower set being conventional blades which are not angled forwards and upwards. We have found that better results may be obtained when the blades (2j to 2s) in the lower set have an angled portion only 1 or 2 mm long, or have a smaller leading edge; such blades are useful to improve the stability of the process, that is decrease the variation of the particle size distribution versus time because they allow mixing without further agglomerating large particles. Good results have also been obtained when the upper pairs of blades in both the first (2a and 2b) and second (2j and 2k) sets of blades have the form shown in FIG. 2.

Alternatively or additionally to the use of blades having a bevelled leading edge (16) as shown in FIG. 2, the mixer can include at least one blade (2) which is mounted at an angle to the shaft (1) so that the whole of the top face of the blade is angled forwards and upwards. For example one or more pair of horizontal blades (2c and 2d, 2e and 2f, 2m and 2n and/or 2p and 2q) can be mounted at such an angle. It may be preferred to use the blades of FIG. 2 for all or some of the blades (2a to 2h) in the upper set and to mount the blades (2m and 2n and/or 2p and 2q) in the lower set angled forwards and upwards at an angle of up to 30 degrees, preferably 5 to 20 degrees, to the horizontal. If the mixer has a third set of blades mounted between the upper set and the lower set, these can be configured similarly to the lower set. This third set can be a full set of blades or may be only one pair of blades extending horizontally from the shaft but angled upwards and forwards by up to 20 or 30 degrees, or two or three such pairs of blades.

One example of a composition which can be granulated in the mixer of the invention is a foam control agent where the active material is a hydrophobic liquid, preferably a silicone or alternatively a mineral oil. The silicone antifoam generally comprises a polyorganosiloxane fluid and preferably also a hydrophobic particulate filler and optionally a silicone resin. The antifoam is usually mixed with a binder, which may for example be a material having a melting point above ambient temperature but is capable of being molten at the operating temperature used for agglomeration. The binder thus generally has a melting point in the range 25 to 100° C., preferably at least 40 or 45° C. up to 80° C. The binder is preferably soluble in water to some extent. Examples of such binders are polyoxyalkylene polymers such as polyethylene glycol (PEG) or ethoxylated C₁₀-C₂₀ alcohols and ethylene oxide, fatty acids or fatty alcohols having 12 to 20 carbon atoms, or a monoester or diester of glycerol and such a fatty acid. Alternatively the binder can be an emulsion, for example an emulsion of an acrylic polymer or a polysiloxane. An alternative liquid active material is a fragrance, which can be mixed with a molten binder such as a hydrophobic wax, preferably a waxy silicone polymer that protects the fragrance from chemical degradation. The liquid active material can alternatively be a hydrophobing additive for cement or gypsum, for example a silicone, which can in general be used with the type of binder used for foam control agents.

Such active liquid materials can be granulated with various solid carrier particles. Examples of carriers are zeolites, for example Zeolite 4A or Zeolite X, other aluminosilicates or silicates, for example magnesium silicate, phosphates, for example powdered or granular sodium tripolyphosphate, sodium sulphate, sodium carbonate, sodium perborate, a cellulose derivative such as sodium carboxymethylcellulose, granulated starch, clay, sodium citrate, sodium acetate, sodium bicarbonate and native starch. The mean particle size of the carrier can for example be in the range 0.5 to 50 or 100 microns. The invention is particularly effective in forming granules from particles of mean diameter less than 20 or 30 microns, for example carrier particles of mean particle diameter in the range 1 to 10 microns. Zeolites, which are widely used carriers because they are inert and have a high absorptive capacity, are generally available only in this particle size range, particularly 1 to 5 microns.

Using the process of the invention granules of mean particle diameter over 0.2 or 0.5 mm, up to a mean diameter of 1.2 or 1.5 or even 2 mm, can be produced consistently even when the particles fed to the mixer are smaller than 10 microns. A very narrow particle size distribution is obtained. When working at high liquid to powder ratio (close to the saturation point) to produce large granules, the process runs in a very stable way, as proven by the very stable current of the mixer electrical motor and stable particle size distribution. When the process conditions to obtain a particular particle size distribution have been determined, this particle distribution stays very stable in time, without frequent need to readjust process parameters.

The invention is illustrated by the following Examples

### EXAMPLE 1

Foam control granules were produced using a Hosokawa Schugi Flexomix mixer of the type shown in FIG. 1, except that the lower set of blades was circumferentially offset to the upper set, and in the lower set only a single pair of horizontal blades (2m, 2n) was present between upwardly extending blades (2j, 2k) and downwardly extending blades (2r, 2s). The carrier particles fed (at 4) to the mixer were zeolite particles of mean diameter 2 to 3 microns. The liquid sprayed (at 5) was a mixture of a siloxane antifoam fluid, hydrophobic silica particles, silicone resin, and a polycarboxylate binder. The weight ratio of liquid to powder feed was 0.497:1 and the total feed rate to the mixer was 7980 kg/hr. The mixer speed was 2800 rpm.

In Example 1, blades having a bevelled leading edge (angle 50 degrees) as shown in FIG. 2 were used as the blades (2a, 2b, 2g and 2h) of the mixer. The particle size of the product at the outlet (7) of the mixer was measured using a light scattering particle size analyzer. The mean particle size of the product was 1.17 mm. The product contained only 6% fines (% by weight of granules smaller than 0.25 mm) and 39% coarses (% by weight of particles larger than 1.40 mm.)

The particle size distribution of the products of Example 1 is shown in comparison to a product C1 made under standard conditions for production of antifoam granules in FIG. 3, in which particle size in micrometres is plotted on the horizontal axis and density distribution (weight of particles in that size range) is plotted on the vertical axis. As can be seen, the granules produced in Example 1 were generally larger and the particle size distribution was much narrower.

The process of Example 1 was continued for 30 minutes. The mean particle size stayed within the range 1.00 to 1.30 mm with substantially the same narrow particle size distribution shown in FIG. 3. Using standard blades (2), we have not found it possible to keep the particle size stable within this range for more than a few minutes.

### EXAMPLE 2

The process of Example 1 was repeated after adjusting the blades (2m and 2n) of the mixer so that they were tilted forwards and upwards at an angle of 20 degrees to the horizontal. The proportion of fines was even lower than in Example 1 as shown by a lower optical concentration viewed near the outlet of the mixer. The process was however less stable than the process of Example 1, with occasional irregular spitting of large lumps of paste from the mixer due to retention of coarse particles near the wall (6) of the mixer. When the size of the tilted blades (2m and 2n) was decreased by a few mm, the mixer could be run continuously for 6 hours without forming large lumps of material.

### EXAMPLE 3

In Example 3, four blades having a bevelled leading edge (angle 45 degrees) as shown in FIG. 2 were used as the blades (2a, 2b, 2g, 2h) of the mixer, with other blades being conventional blades. The mixer blade speed was held at 2400 rpm for 5 hours (Period A), then at 2800 rpm for 5 hours (Period B), then at 2400 rpm for 2 hours (Period C). The granulated product of the mixer was fed to a fluidised bed, and fines (less than 0.2 mm) were recirculated. During Period A, the proportion of fines recirculated was 25% and the mean particle size of the granules stayed over 0.8 mm for a period of 3 hours; this proportion of fines was lower than previous running of the mixer with conventional blades producing granules of particle size 0.4-0.5 mm. The proportion of fines increased somewhat during Periods B and C with a lowering of mean particle size, but smooth running was achieved for the full 12 hour trial.

### EXAMPLE 4

Example 4 was carried out using a mixer of the general design shown in FIG. 1 but having a third set of blades (2t, 2u, 2v, 2w, 2x, 2y) between the upper and the lower set of blades and arranged relative to each other and to the shaft (1) similarly to blades (2j, 2k, 2m, 2n, 2r, 2s) respectively. The blades (2a to 2s) of the first and second sets were as described in Example 3. The non-horizontal blades (2t, 2u, 2x, 2y) of the third set were smaller blades (a few mm. shorter) and were arranged at an angle of 20° forwards and upwards to their direction of travel. The horizontal blades (2v, 2w) were conventional blades. The mixer blade speed was 2400 rpm. The proportion of fines produced was similar to Period A of Example 3 and the process remained very stable.

### EXAMPLE 5

In Example 5, three sets of blades were used. Four blades as shown in FIGS. 2 and 3 were used as the blades (2g, 2h, 2t, 2u) of the mixer. All other blades were conventional blades. The mixer blade speed was 2400 rpm. The proportion of fines produced was below 25% and the process was very stable, with low turbulence and a low concentration of particles near shaft (1) at the outlet (7) of the mixer.

1. A mixer blade adapted to be mounted on the shaft of a vertical continuous granulating mixer, characterised in that an inner portion of the leading edge of the blade is bevelled upwards and an outer portion of the leading edge of the blade is substantially vertical or is bevelled downwards.

2. A mixer blade according to claim 1, characterised in that the leading edge of the inner portion of the blade is bevelled upwards at an angle of 30 to 75 degrees to its direction of travel when mounted on the shaft.

3. A mixer blade according to claim 1 or claim 2, characterised in that the leading edge of the outer portion of the blade is bevelled downwards at an angle of 45 to 80 degrees to its direction of travel when mounted on the shaft.

4. A mixer blade according to any of claims 1 to 3, characterised in that the inner portion of the blade whose leading edge is bevelled upwards is immediately adjacent to the outer portion of the blade whose leading edge is bevelled downwards.

5. A mixer blade according to claim 4, characterised in that the transition point between the inner portion of the blade whose leading edge is bevelled upwards and the outer portion of the blade whose leading edge is bevelled downwards is positioned at 50 to 80% of the distance from the point where the blade is secured to the shaft to the tip of the blade.

6. A vertical continuous granulating mixer comprising a shaft fitted with blades rotating within a tubular housing and having an inlet for solid particles and a spray inlet for liquid to contact the solid particles above the blades, characterised in that an inner portion of at least one of the blades is angled forwards and upwards over at least part of its area so that particles hitting the angled portion of the blade acquire an upwards velocity component.

7. A vertical continuous granulating mixer according to claim 6, characterised in that the leading edge of at least one of the blades is bevelled upwards.

8. A vertical continuous granulating mixer comprising a shaft fitted with blades rotating within a tubular housing and having an inlet for solid particles and a spray inlet for liquid to contact the solid particles above the blades, characterised in that at least one of the blades is a mixer blade according to any of claims 1 to 5.

9. A vertical continuous granulating mixer according to claim 8, characterised in that the uppermost blade or blades is according to any of claims 1 to 5 and the mixer includes at least one lower blade which does not have a bevelled leading edge.

10. A vertical continuous granulating mixer having an upper set of blades and a lower set of blades, characterised in that at least one blade of the upper set is angled forwards and upwards over at least part of its area according to any of claims 6 to 9 and the blades of the lower set are not angled forwards and upwards.

11. A mixer according to claim 10, characterised in that the mixer has three sets of blades, and at least one blade of the upper set and at least one blade of the middle set are angled forwards and upwards over at least part of its area according to any of claims 6 to 9 and the blades of the lower set are not angled forwards and upwards.

12. A granulation process in which solid particles and a liquid having binding properties are fed to a mixer and are contacted in the mixer to form granules, characterised in that the mixer is a vertical continuous granulating mixer according to any of claims 6 to 11.

13. A process according to claim 12 characterised in that the particles fed to the mixer are carrier particles of mean particle size in the range 1 to 10 microns.

14. A process according to claim 12 or claim 13 characterised in that the mean particle size of the granules produced is in the range 0.5 to 1.5 mm.
